(19) United States
(12) Patent Application Publication
(10) Pub. No.: US 2013/0235298 A1
(43) Pub. Date: Sep. 12, 2013

(54) DISPLAY DEVICE

(71) Applicant: Takaaki Harada, Osaka (JP)

(72) Inventor: Takaaki Harada, Osaka (JP)

(73) Assignee: SHARP KABUSHIKI KAISHA, Osaka (JP)

(21) Appl. No.: 13/881,316

(22) PCT Filed: Oct. 25, 2011
(86) PCT No.: PCT/JP2011/074474

§ 371 Date: Apr. 24, 2013

(30) Foreign Application Priority Data
Nov. 1, 2010 (JP) 2010-245516

(51) Int. Cl. G02F 1/1333

(52) U.S. Cl. CPC G02F 1/133308
USPC 349/58

(57) ABSTRACT

A display panel (30) is formed in a rectangular plate shape provided with a display surface, a rear surface, and four end surfaces. A first bezel (10) covers: at least a portion of the rear surface (39) of the display panel (30); opposite end faces (32, 33) of the display panel (30); and peripheral portions of the display surface (31) along the opposite end faces (32, 33). Second bezels (20, 40) are respectively formed in a box shape having an opening (22, 42) that opens in one direction only. The openings (22, 42) of the second bezels (20, 40) respectively encloses end faces (34, 35) that are not covered by the first bezel (10), peripheral portions (31c, 31d) of the display surface (31) along the end faces (34, 35), and side end portions (101, 104) and side end portions (102, 103) of the first bezel (10) covering the opposite end surfaces (34, 35).

### TECHNICAL FIELD

The present invention relates to a display device equipped with a bezel.

### BACKGROUND ART

In a liquid crystal display device, for example, a liquid crystal panel and a backlight device that illuminates the liquid crystal panel are housed in a frame (resin or metal frame), thereby being held as one component. Around this frame, a supporting frame called bezel is attached. The bezel is formed by stamping a metal plate into a frame shape. By providing such a metal bezel, the strength of a liquid crystal display device can be improved, and it is also possible to prevent contamination and light leakage that are likely to occur at the periphery of a liquid crystal panel. In particular, many of 10-inch to 20-inch liquid crystal panels employ a configuration in which the above-mentioned frame assembly including a liquid crystal panel and a backlight device is held between a front bezel and a rear bezel.

A conventional bezel structure as described above will be explained with reference to FIG. 11. FIG. 11A is an exploded perspective view of a liquid crystal display device that uses a conventional bezel. In FIG. 11A, a frame (not shown), a backlight device (not shown), and a liquid crystal panel 220 are stacked in this order in a rear bezel 240.

The rear bezel 240 has a plurality of tabs 242 formed on the side faces on the periphery thereof. On the inner walls around a front bezel 210, a plurality of tabs 212 are formed. Although FIG. 11A only shows the tabs on one side of each of the front bezel 210 and the rear bezel 240, a plurality of tabs are also formed on sides opposite to the respective one sides of the front bezel 210 and the rear bezel 240.

FIG. 11B is a front cross-sectional view of a cross section cutting through the tab 212 and the tab 242 when the front bezel 210 is moved in the direction Y and is placed on the rear bezel 240. In FIG. 11B, in a recessed portion formed on the top side of the rear bezel 240, a frame 250, a backlight device 230, and a liquid crystal panel 220 are stacked and placed in this order.

When the front bezel 210 is placed on the rear bezel 240, the tab 212 formed on the side wall 211 of the front bezel 210 makes contact with a side face 241 of the rear bezel 240, and the tab 212 is elastically deformed away from the side face 241 as a result of being pressed by the side face 241 of the rear bezel 240. When the front bezel 210 is further pushed down, and the tab 212 reaches the bottom of the tab 242 of the rear bezel 240, the tab 212 engages with the tab 242 due to elastic recovery. As a result, the rear bezel 240 is fixed to the front bezel 210, sandwiching the frame 250, the backlight device 230, and the liquid crystal panel 220 therebetween.

A liquid crystal display device configured such that after a liquid crystal display panel is placed in a frame body, a connecting portion between the liquid crystal display panel and a flexible printed circuit is supported from above and below is also known (see Patent Document 1, for example).

### RELATED ART DOCUMENT

### Patent Document

Patent Document 1 Japanese Patent Application Laid-Open Publication No. 2003-28004

### SUMMARY OF THE INVENTION

### Problems to be Solved by the Invention

However, the above-mentioned conventional technologies have the following problems, respectively. First, in the configuration using a front bezel and a rear bezel, it is necessary to have the plurality of tabs 212 of the front bezel 210 engaged with the plurality of tabs 242 of the rear bezel 240, and the engaging state of each tab needs to be confirmed thereafter. As a result, a step of attaching the front bezel 210 and the rear bezel 240 to the liquid crystal display panel 220, which are assembled with a frame and a backlight device, is made complex, which causes a problem. For example, if the tabs 212 and 242 are not engaged properly due to an error in the process, the front bezel 210 and the rear bezel 240 cannot be securely fixed to each other.

Also, if the tabs are disengaged due to a defect in bezel components after attaching the front bezel 210 and the rear bezel 240 to the liquid crystal display panel 220, the front bezel 210 and the rear bezel 240 cannot be securely fixed to each other, similar to above.

If the front bezel 210 and the rear bezel 240 are not securely fixed, the strength of the liquid crystal display device cannot be maintained, possibly causing damage to the liquid crystal display panel 220. It is also possible to cause degradation of display quality due to contamination and light leakage that occur at the periphery of the liquid crystal display panel 220.

On the other hand, in the configuration of Patent Document 1, because there is no component that corresponds to tabs for fixing bezels, the process of placing a liquid crystal display panel in a frame body is not likely to be made complex, or a problem of disengaging tabs due to a defect in bezel components does not occur.

However, in the configuration of Patent Document 1, the periphery of an upper polarizing plate (display surface side) of the liquid crystal display panel is not covered by a frame body. This makes contamination and light leakage more likely to occur at the periphery of the liquid crystal display panel, resulting in degradation of display quality.

The present invention was made in view of the above-mentioned problems, and an object thereof is to provide a display device that can make a process of attaching a bezel to a display panel simpler and that can prevent degradation of display quality due to damage of the display panel, contamination, or light leakage.

### Means for Solving the Problems

A display device of the present invention includes: a display panel; a first bezel; and second bezels, wherein the display panel is formed in a rectangular plate shape having a display surface, a rear surface opposite to the display surface, and four end faces continued from the display surface and the rear surface, wherein the first bezel covers at least a part of the rear surface of the display panel, opposite end faces of the display panel, and peripheral portions of the display surface along the opposite end faces, wherein the second bezels are respectively formed in a box shape having an opening that opens in one direction only, and wherein the openings of the second bezels respectively enclose end faces of the display panel not covered by the first bezel, peripheral portions of the display surface along the end faces not covered by the first bezel, and side end portions of the first bezel that covers the opposite end faces of the display panel.

### Effects of the Invention

According to the display device of the present invention, the first bezel covers at least a part of the rear surface of the display panel, opposite end faces of the display panel, and peripheral portions of the display surface along the opposite end faces. The second bezels are respectively formed in a box shape having an opening that opens in one direction only, and the openings of the second bezels respectively enclose end faces of the display panel not covered by the first bezel, peripheral portions of the display surface along the end faces not covered by the first bezel, and side end portions of the first bezel covering the opposite end faces of the display panel. First, at least a part of the rear surface of the display panel, opposite end faces, and peripheral portions of the display surface along the opposite end faces are covered by the first bezel, and then end faces of the display panel not covered by the first bezel, peripheral portions of the display surface along the end faces not covered by the first bezel, and side end portions of the first bezel covering the opposite end faces of the display panel are placed in the openings of the second bezels, respectively. This makes it possible to make a process of attaching bezels to the display panel simpler.

Also, because the first bezel can be placed and pressed in the openings of the box-shaped second bezels, damage to a liquid crystal panel caused by the bezels coming off is not unlikely to occur. Further, by covering the peripheral portions of the display panel with the first bezel and the second bezels, it is possible to prevent contamination and light leakage at the periphery of the display panel.

### BRIEF DESCRIPTION OF THE DRAWINGS

FIG. 1 is an exploded perspective view of a liquid crystal display device 1 that includes a first bezel 10 and a display panel 30.

FIG. 2A is an enlarged front view around an end portion 13 when the display panel 30 is placed on the first bezel 10.

FIG. 2B is an enlarged front view showing a state after the first bezel 10 is folded along the bottom portion 331 of an end face 33.

FIG. 3 is a perspective view showing a state in which the display panel 30 and the first bezel 10 are assembled, and showing second bezels 20 and 40.

FIG. 4A is an enlarged perspective view of the second bezel 20 shown in FIG. 3.

FIG. 4B is an enlarged perspective view of the second bezel 40 shown in FIG. 3.

FIG. 5 is a perspective view of the liquid crystal display device 1 provided with the second bezels 20 and 40 after attaching the first bezel 10 to the display panel 30.

FIG. 6 shows an end portion of a cross-sectional view along the portion 6-6 of FIG. 5.

FIG. 7A is an exploded plan view for illustrating a display device according to Embodiment 2.

FIG. 7B is a plan view of the liquid crystal display device 1 provided with the second bezels 20 and 40 after attaching the first bezel 10 to the display panel 30.

FIG. 8 is a partial enlarged view around a tab 27 of the second bezel 20.

FIG. 9A is a partial enlarged view around a tab 17 of the first bezel 10.

FIG. 9B is a partial enlarged view of a modification example in which a hole 19 is provided instead of the tab 17 of the first bezel 10.

FIG. 10A is an exploded perspective view for illustrating a display device according to Embodiment 3.

FIG. 10B is a perspective view of the liquid crystal display device 1 in which two third bezels 80 are attached to the display panel 30 that has the first bezel 10 (not shown) and the second bezels 20 and 40 attached thereto.

FIG. 11A is an exploded perspective view of a liquid crystal display device that uses a conventional bezel.

FIG. 11B is a front cross-sectional view of a cross section cutting through a tab 212 and a tab 242.

### DETAILED DESCRIPTION OF EMBODIMENTS

In a display device according to one embodiment of the present invention, it is preferable that a first bezel be folded in advance at a substantially right angle at a position that faces a boundary between an end face and a display surface covered by the first bezel. This makes it possible to improve a work efficiency in attaching the first bezel to the display panel.

In the display device according to one embodiment of the present invention, it is preferable that an engaging structure that holds the first bezel and the second bezel be provided at a position where the first bezel and the second bezel make contact with each other. This makes it possible to hold the first bezel and the second bezel more reliably.

The display device according to one embodiment of the present invention may further include third bezels respectively formed in a box shape having an opening in one direction only, and end faces of the first bezel that covers the opposite end faces, end portions of the first bezel that covers the peripheral portions of the display surface along the opposite end faces, and end portions of the second bezels in a lengthwise direction may be placed in the openings of the third bezels, respectively. This makes it possible to further improve the strength of the display device, and it is possible to effectively prevent contamination from the end faces of the liquid crystal panel and light leakage from the end portions thereof.

Below, embodiments of the present invention will be specifically explained with reference to figures. In the descriptions below, an example of using the present invention for a transmissive liquid crystal display device will be explained. The dimensions of constituting members in respective figures do not truthfully represent the dimensions of actual constituting members, dimensional ratios of the respective constituting members, and the like.

### Embodiment 1

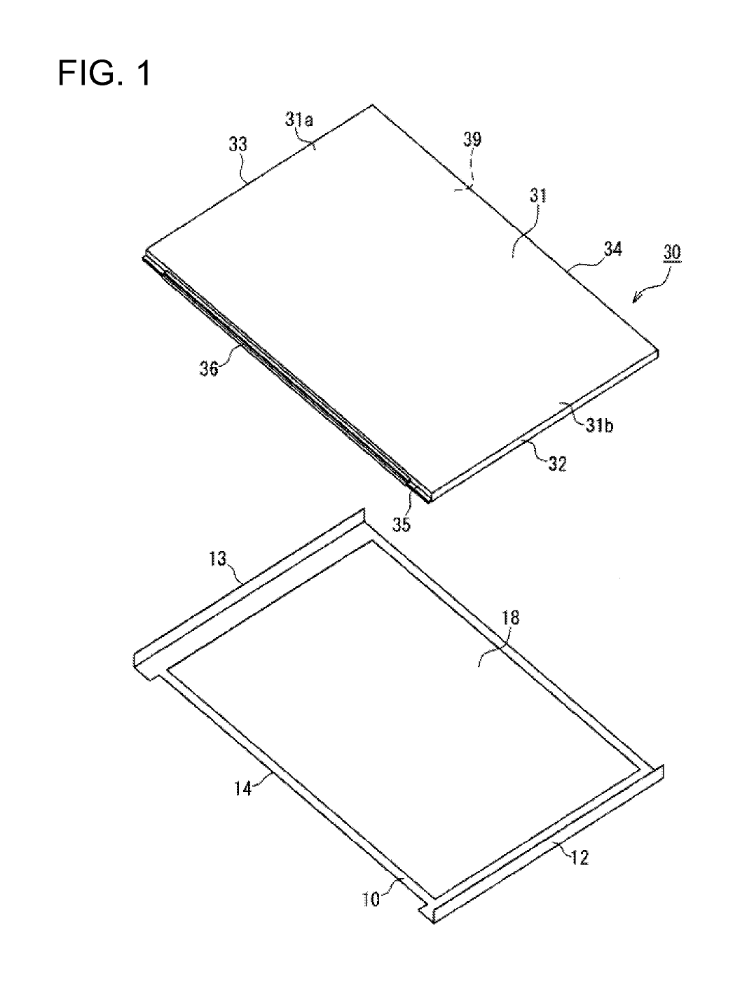

FIGS. 1 to 6 schematically show a manufacturing process of a liquid crystal display device 1 of one embodiment of the present invention.

FIG. 1 is an exploded perspective view of a liquid crystal display device 1 that includes a first bezel 10 and a display panel 30. The display panel 30 shown in FIG. 1 is formed by stacking a backlight device and a liquid crystal panel in this order and holding them as one component, for example. The display panel 30 is formed in a rectangular plate shape that has a display surface 31 displaying images, a rear surface 39 opposite to the display surface, and four end faces 32, 33, 34, and 35 continued from the display surface 31 and the rear surface 39. A part of the periphery of the display surface 31 along the end face 32 is a peripheral portion 31b, and a part of the periphery of the display surface 31 along the end face 33 is a peripheral portion 31a.

As shown in FIG. 1, the end faces 32 and 33 opposite to each other are end faces that are continued from the shorter sides of the display surface 31, and the end faces 34 and 35 opposite to each other are end faces that are continued from the longer sides of the display surface 31. On the outer side of the end face 35 of the display panel 30, a flexible substrate 36 connected to the liquid crystal panel is folded along the end face 35.

The first bezel 10 shown in FIG. 1 is a substantially rectangular plate-shaped member formed by stamping a metal such as aluminum or stainless steel, for example. A penetrating hole 18 is formed in the center of the first bezel 10. In the present invention, it is not necessary to form the penetrating hole 18 in the first bezel 10, but by forming the penetrating hole 18, weight reduction and heat discharge effect can be achieved.

In the first bezel 10, opposite end portions 12 and 13 are folded at a substantially right angle in advance so as to improve the efficiency in the attachment process of the first bezel. The first bezel 10 also has a notch 14 formed at a position that faces the flexible substrate 36 of the display panel 30 such that the flexible substrate 36 can be led out.

On the flat table in work space that is larger than the outer shape of the display panel 30, the first bezel 10 is placed with the end portions 12 and 13 facing up. The display panel 30 is placed on the first bezel 10 such that the first bezel 10 covers at least part of the rear surface 39 of the display panel 30. In this case, because it is possible to place the display panel 30 after aligning it to the first bezel 10 from above, the work accuracy in attaching the first bezel to the display panel 30 is unlikely to be reduced.

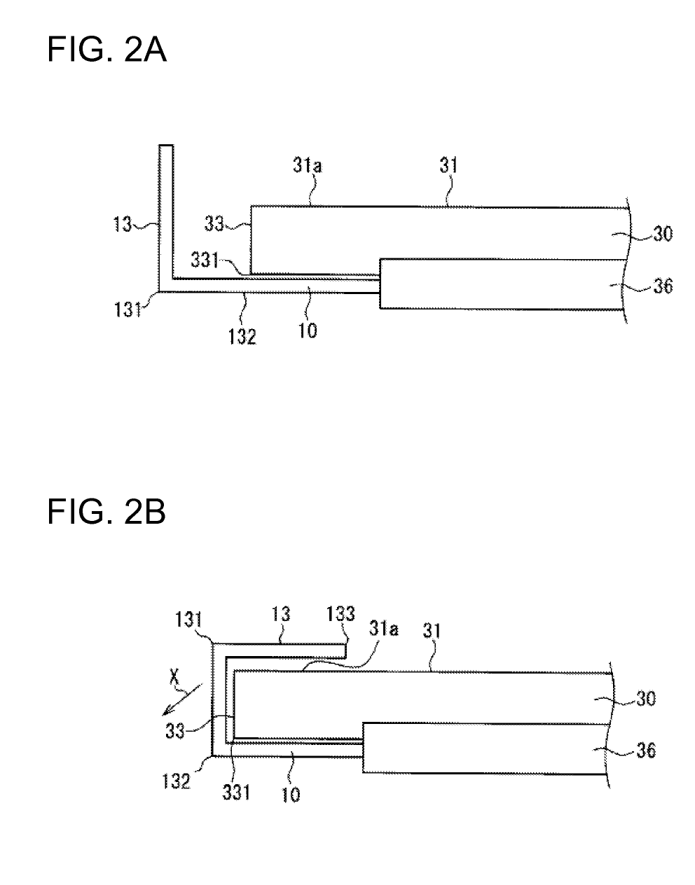

FIG. 2A is an enlarged front view around the end portion 13 of the first bezel 10 after the display panel 30 is placed on the first bezel 10. In the end portion 13, a portion 131 that will face the boundary between the end face 33 and the display surface 31 to be covered by the first bezel when the first bezel 10 is attached to the display panel 30 is folded in advance at a substantially right angle.

As shown in FIG. 2B, after placing the display panel 30 on the first bezel 10, a part of the first bezel 10 around a portion 132 is folded along the bottom portion 331 of the end face 33 such that the first bezel 10 covers the end face 33 of the display panel 30. A slit may be formed in advance in the inner surface or the outer surface of the portion 132 that faces the bottom portion 331 of the end face 33 so as to make it easier to fold the first bezel 10. As shown in FIG. 2B, in order to prevent light leakage and contamination at the end face 33, the first bezel is formed in a shape that covers the peripheral portion 31a of the display surface 31 along the end face 33.

It is preferable to fold the portion 132 at a right angle with a slight elastic deformation in the folding direction. This is because, when boxed-shaped second bezels 20 and 40, which will be described later, are attached, an elastic recovery occurs at the portion 132 in the direction of the arrow X of FIG. 2B, which brings a portion 133 of first bezel 10 into contact with an inner wall of each of the second bezels 20 and 40, making it easier to hold them in place.

The structure at the end portion 13 of the first bezel 10 was described above, but the end portion 12, located at the opposite side to the end portion 12 has a similar structure.

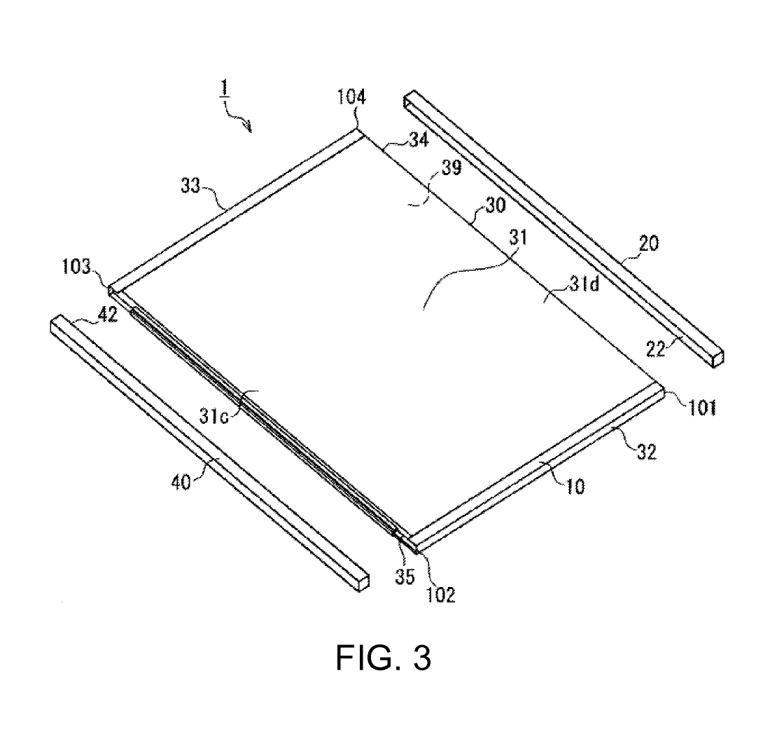

As described above, the first bezel is attached so as to cover at least a part of the rear surface 39 of the display panel 30, the opposite end faces 32 and 33 of the display panel 30, and the peripheral portions 31a and 31b of the display surface 31 along the opposite end faces 32 and 33, and as shown in FIG. 3, the display panel 30 and the first bezel 10 are assembled.

After assembling the display panel 30 and the first bezel 10, as shown in FIG. 3, box-shaped second bezels 20 and 40 are attached to the respective end faces 34 and 35 that are not covered by the first bezel 10 out of the end faces of the display panel 30. A part of the periphery of the display surface 31 along the end face 35 is a peripheral portion 31c, and a part of the periphery of the display surface 31 along the end face 34 is a peripheral portion 31d. The length of the second bezels 20 and 40 in the lengthwise direction is substantially the same as that of the end faces 34 and 35 in the lengthwise direction.

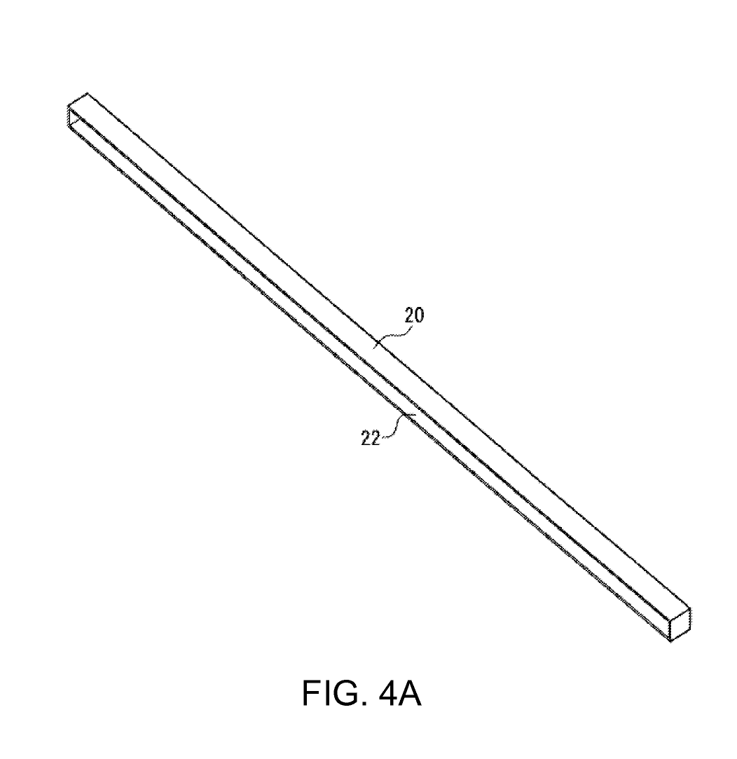

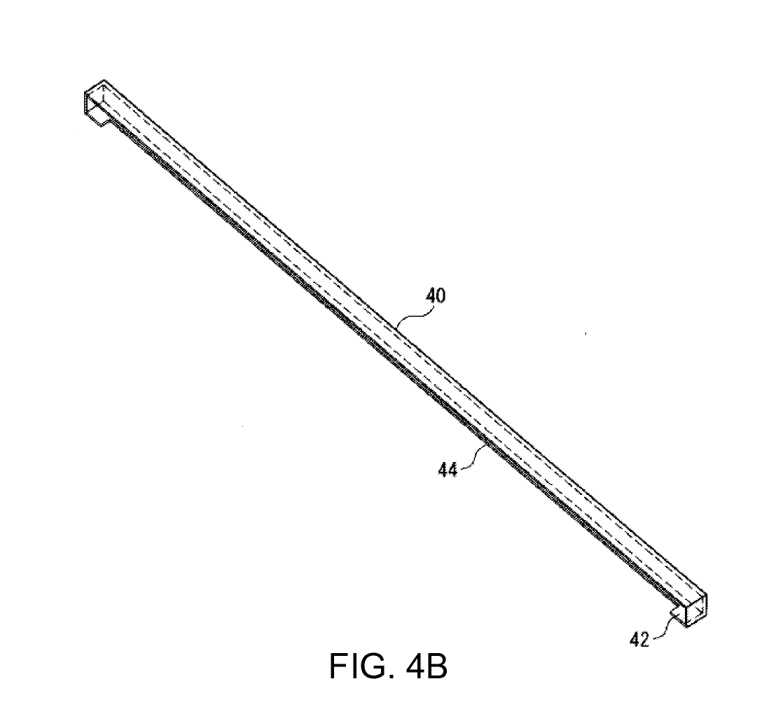

FIG. 4A is an enlarged perspective view of the second bezel 20 of FIG. 3. As shown in FIG. 4A, the second bezel 20 is formed in a box shape that has an opening 22 that opens in one direction only. The edge of the opening 22 is formed in a rectangular frame shape. The second bezel 20 is formed by stamping a metal such as aluminum or stainless steel, for example. Alternatively, the second bezel 20 may be formed of a resin such as polycarbonate by injection-forming.

As shown in FIG. 3, the second bezel 20 is attached such that the opening 22 thereof encloses the end face 34 not covered by the first bezel 10 of the end faces of the display panel 30, the peripheral portion 31d of the display surface 31 along the end face 34 not covered by the first bezel 10, and side end portions 101 and 104 of the first bezel 10 that covers the end face 32 of the display panel 10.

FIG. 4B is an enlarged perspective view of the second bezel 40 of FIG. 3. As shown in FIG. 4B, the second bezel 40 is formed in a box shape that has an opening 42 that opens in one direction only in a manner similar to the second bezel 20 of FIG. 4A. However, the second bezel 40 differs from the second bezel 20 in that a notch 44 for leading out the flexible substrate 36 is provided. The notch 44 is formed in a position that faces the flexible substrate 36. The second bezel 40 is obtained by forming a metal or a resin, similar to the second bezel 20.

As shown in FIG. 3, the second bezel 40 is attached such that the opening 42 thereof encloses the end face 35 not covered by the first bezel 10 of the end faces of the display panel 30, the peripheral portion 31c of the display surface 31 along the end face 35 not covered by the first bezel 10, the flexible substrate 36 provided on the outer side of the end face 35, and side end portions 102 and 103 of the first bezel 10 covering the end face 33 of the display panel 10.

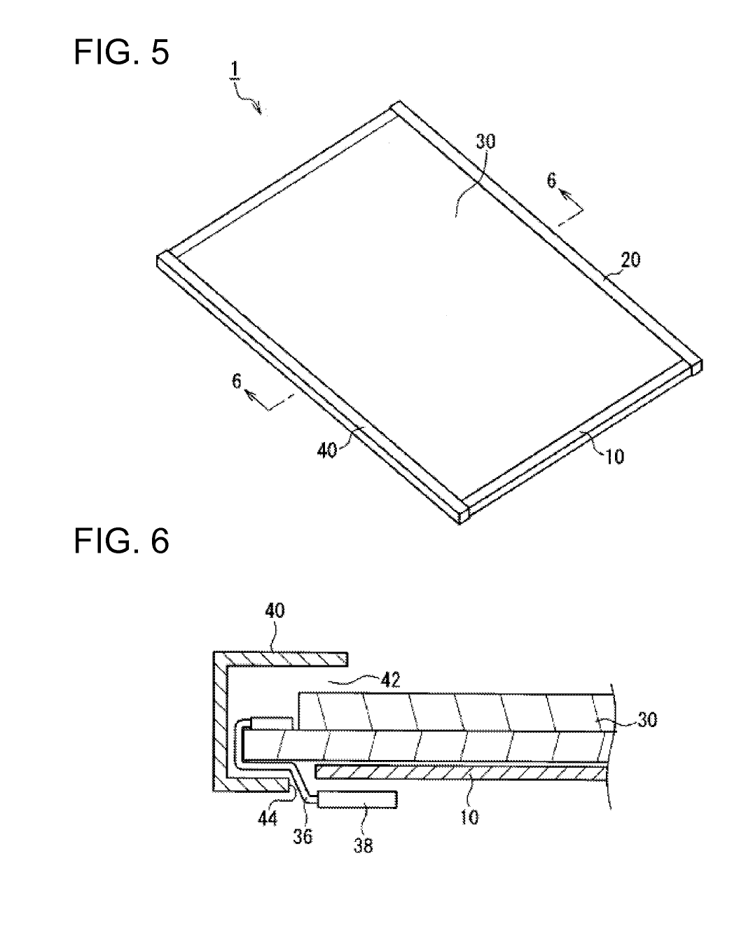

FIG. 5 is a perspective view of the liquid crystal display device 1 in which the second bezel 20 and the second bezel 40 are provided after attaching the first bezel 10 to the display panel 30. In the liquid crystal display device 1, the edges of the openings 22 and 42 of the second bezels 20 and 40 are formed in a rectangular frame shape, and therefore, the first bezel 10 and the second bezels 20 and 40 are engaged more strongly, thereby increasing the strength of the device.

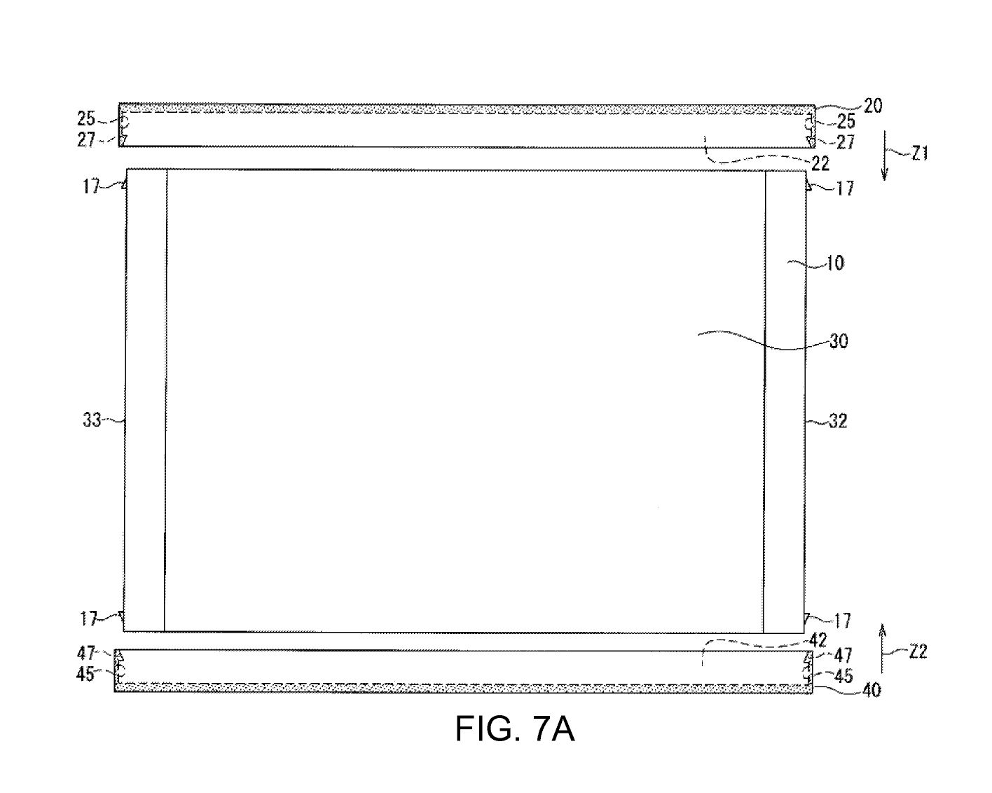

FIG. 6 shows an end portion of a cross-sectional view along the portion 6-6 of FIG. 5. As shown in FIG. 6, the second bezel 40 is attached to the display panel 30 such that a connector 38 of the flexible substrate 36 can be connected to the outside through the notch 44.

In the manner described above, the first bezel 10, the second bezel 20, and the second bezel 40 are attached to the display panel 30. The liquid crystal display device 1 of the present embodiment is completed in this way.

In the descriptions above, the end faces 32 and 33 on the shorter sides of the display surface 31 in the display panel 30 are covered by the first bezel, and the end faces 34 and 35 on the longer sides thereof are covered by the second bezels, respectively. However, alternatively, it is possible switch the end faces on the shorter sides with the end faces on the longer sides, and the end faces 34 and 35 on the longer sides may be covered with the first bezel, and the end faces 32 and 33 on the shorter sides may be covered with the second bezels, respectively.

### Embodiment 2

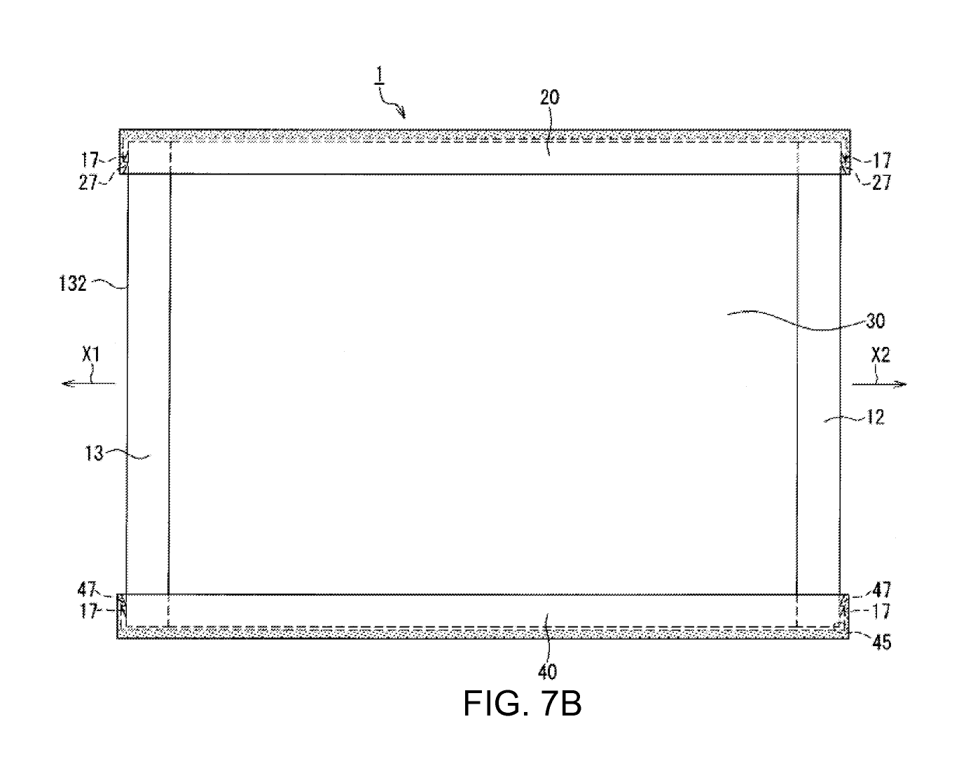

In Embodiment 2, an engaging structure is provided at a position where the first bezel 10 and the second bezel 20 or 40 are in contact with each other. Examples of the engaging structure include a structure in which tabs are engaged, a structure in which a tab and a hole are engaged, and the like. FIG. 7A is an exploded plan view for illustrating a display device according to Embodiment 2. The same reference characters are given to components and elements that are common with Embodiment 1 above, and duplicative descriptions are omitted.

As shown in FIG. 7A, in the present embodiment, the first bezel 10 has a plurality of first tabs 17 formed on the back side of the portions thereof that face the end faces 32 and 33 of the display panel 30. The second bezel 20 has second tabs 27 that are formed to engage with the first tabs 17 on the inner side walls 25 in the side end portions of the opening 22. The second tabs 27 are formed in positions that face the first tabs 17. Similarly, the second bezel 40 has second tabs 47 that are formed to engage with the first tabs 17 on the inner side walls 45 in the side end portions of the opening 42. The second tabs 47 are formed in positions that face the first tabs 17.

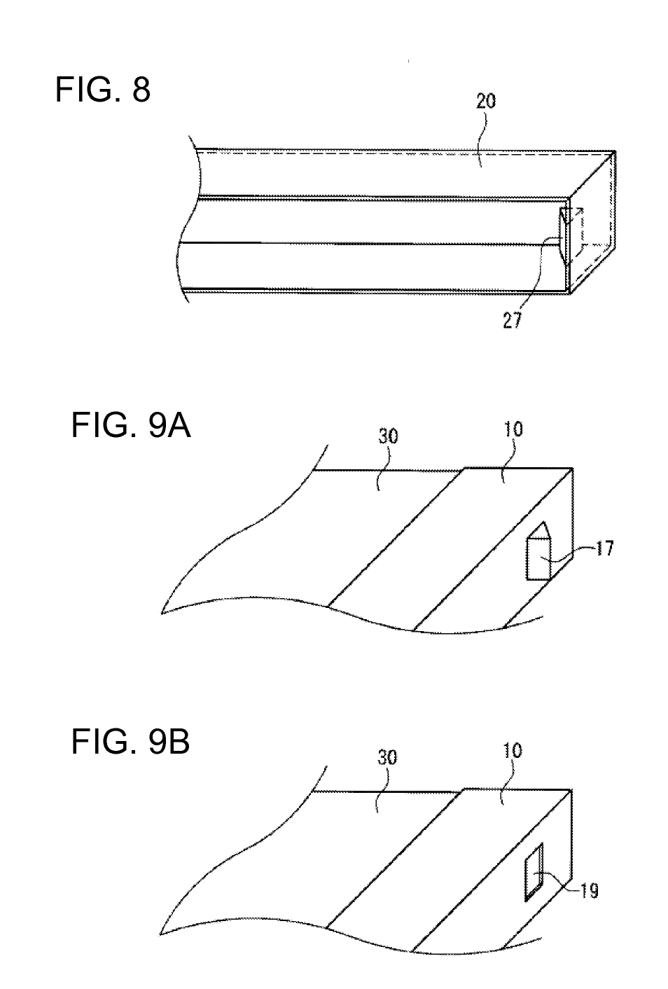

FIG. 8 is a partial enlarged view around the second tab 27 of the second bezel 20. The second tab 47 of the second bezel 40 has the same shape as the second tab 27. FIG. 9A is a partial enlarged view around the first tab 17 of the first bezel 10.

In FIG. 7A, by moving the second bezel 20 in the direction of the arrow Z1, the second bezel 20 is attached to the display panel 30 that has the first bezel 10 attached thereto. Also, by moving the second bezel 40 in the direction of the arrow Z2, the second bezel 40 is attached to the display panel 30 that has the first bezel 10 attached thereto.

In this manner, the first tabs 17 of the first bezel 10 and the second tabs 27 of the second bezel 20 are engaged with each other, and the first tabs 17 of the first bezel 10 and the second tabs 47 of the second bezel 40 are engaged with each other, thereby obtaining the state shown in FIG. 7B.

In this case, the first bezel 10 and the second bezels 20 and 40 are fixed to each other by the engaging structures provided at four locations only, and therefore, as compared to the conventional configuration in which a plurality of tabs are provided to each side of the bezel, it is possible to reduce the number of tabs that need to be checked. As a result, the process time can be shortened, and the occurrence of overlooking erroneous engagement can be reduced.

Also, as described above, it is preferable to fold the portion 132 (shown in FIG. 2) in the end portion 13 of the first bezel 10 at approximately a right angle with a slight elastic deformation in the folding direction. As shown in FIG. 7B, when the second bezels 20 and 40 are attached, elastic recovery occurs at the portion 132 in the direction of the arrow X1 of FIG. 7B, and therefore, it makes it easier for the tabs 17 of the first bezel 10 and the tabs 27 and 47 of the second bezels 20 and 40 to engage with each other. As a result, it is possible to provide a margin in the processing accuracy of each tab. Similarly, in the end portion 12 of the first bezel, it is preferable to fold a portion of the first bezel 10 such that elastic recovery occurs in the direction of the arrow X2, thereby making it easier for the tabs 17 of the first bezel 10 and the tabs 27 and 47 of the second bezel 20 and 40 to engage with each other.

In the manner described above, the first bezel 10, the second bezel 20, and the second bezel 40 are attached to the display panel 30. The liquid crystal display device 1 of the present embodiment is completed in this way.

As shown in FIG. 9B, a hole 19 may be formed instead of the first tab 17 of the first bezel 10. By having the second tab 27 of the second bezel 20 and the second tab 47 of the second bezel 40 engage with the holes 19 of the first bezel 10, it is possible to make a gap between the first bezel 10 and the second bezel 20 or between the first bezel 10 and the second bezel 40 smaller as compared with the case in which the first tabs 17 are provided. This makes it possible to hold the first bezel and the second bezel more securely.

FIGS. 7A and 7B above showed the configuration in which the first tabs 17 are provided at four locations in the first bezel 10, and the second tabs 27 and 47 are provided in the second bezels 20 and 40 at respective positions that face the first tabs 17, but the position and the number of each tab can be appropriately set. For example, one or two or more pairs of the first tabs and the second tabs may be provided on each surface where the first bezel 10 and the second bezel 20 or 40 make contact with each other. This makes it possible to fix the first bezel 10 and the second bezels 20 and 40 to each other more securely.

### Embodiment 3

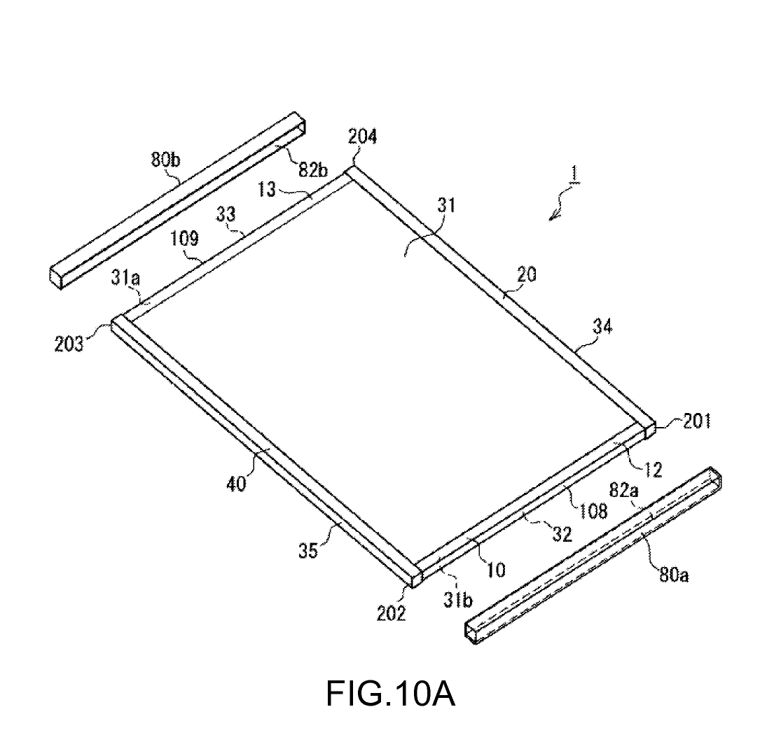

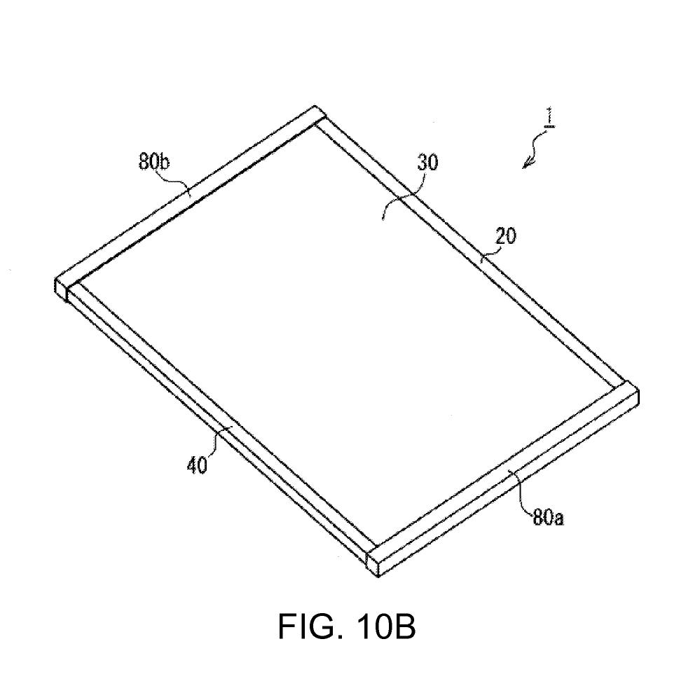

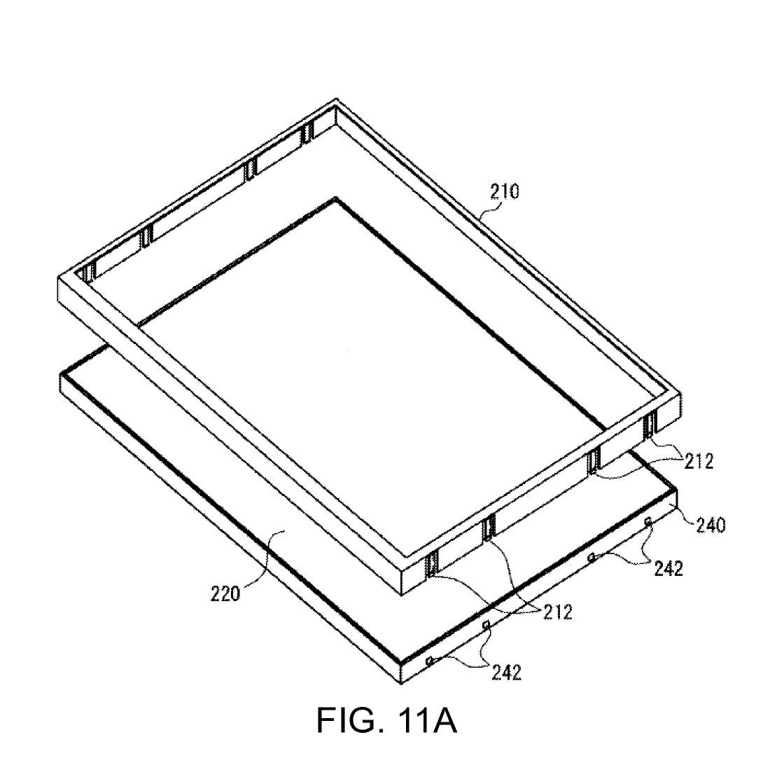

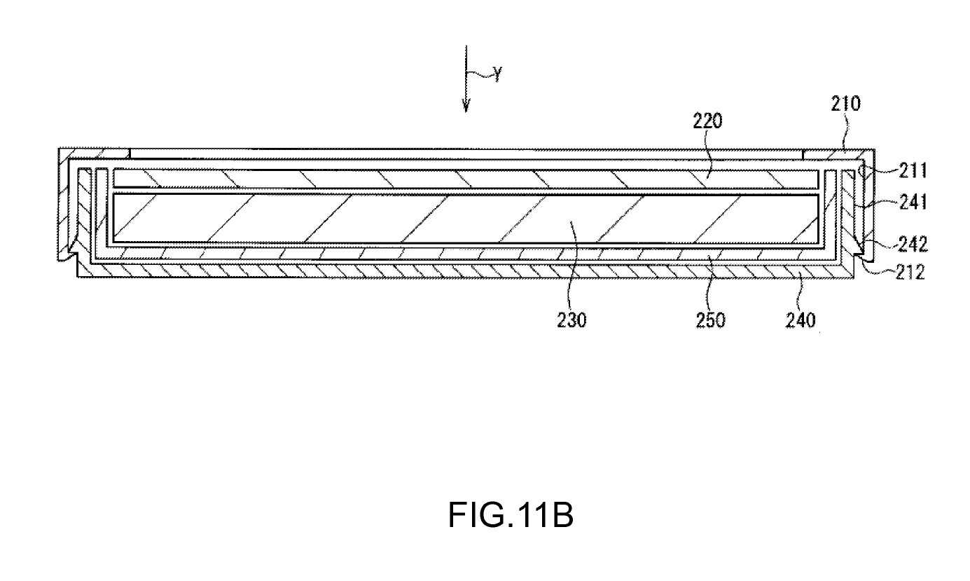

In Embodiment 3, the display device having the first bezel and the second bezel attached thereto is further provided with third bezels. FIG. 10A is an exploded perspective view illustrating a display device of Embodiment 3. The same reference characters are given to components and elements that are common with Embodiment 1 above, and duplicative descriptions are omitted.

As shown in FIG. 10A, a third bezel 80a is formed in a box shape that has an opening 82a that opens in one direction only, in a manner similar to the second bezels 20 and 40. The length of the third bezel 80a in the lengthwise direction is substantially the same as that of the end faces 32 and 33 of the display panel 30 in the lengthwise direction.

As shown in FIG. 10A, the third bezel 80a is attached such that the opening 82a thereof encloses an end face 108 of the first bezel 10 covering the end face 32, the end portion 12 of the first bezel 10 covering the peripheral portion 31b of the display surface 31 along the end face 32, and end portions 201 and 202 of the second bezels 20 and 40 in the lengthwise direction.

Similarly, the other third bezel 80b, which is opposite to the third bezel 80a, is attached such that the opening 82b thereof encloses an end face 109 of the first bezel 10 covering the end face 33, the end portion 13 of the first bezel 10 covering the peripheral portion 31a of the display surface 31 along the end face 33, and end portions 204 and 203 of the second bezels 20 and 40 in the lengthwise direction.

FIG. 10B is a perspective view of the liquid crystal display device 1 in which the two third bezels 80a and 80b are respectively attached to the display panel 30 having the first bezel 10 (not shown) and the second bezels 20 and 40 attached thereto.

In the manner described above, the first bezel 10, the second bezel 20, the second bezel 40, the third bezel 80a, and the third bezel 80b are attached to the display panel 30. The liquid crystal display device 1 of the present embodiment is completed in this way.

The liquid crystal display device 1 of the present embodiment may also be provided with the engaging structure described in Embodiment 2 above. For example, an engaging structure using tabs or holes may be provided at each position where the third bezel 80a or the third bezel 80b makes contact with each of the first bezel 10, the second bezel 20, and the second bezel 40. This makes it possible to fix the third bezel 80a or the third bezel 80b to each of the first bezel 10, the second bezel 20, and the second bezel 40 more securely.

### INDUSTRIAL APPLICABILITY

There is no special limitation on the applicability of the present invention, and the present invention can be used for any display device having a display panel in a rectangular plate shape.

### DESCRIPTION OF REFERENCE CHARACTERS

1 liquid crystal display device (display device)
10 first bezel
12, 13 end portions of the first bezel that covers peripheral portions of a display surface along the opposite end faces
17, 27, 47 engaging structure (tab) for fixing the first bezel and second bezel
20 second bezel
22 opening of the second bezel 20
30 display panel
31 display surface
31a, 31b, 31c, 31d peripheral portion of the display surface
32, 33, 34, 35 four end faces continued from display surface and rear surface
32, 33 opposite end faces of the display panel
34, 35 end faces not covered by the first bezel
39 rear surface opposite to the display surface
40 second bezel
42 opening of the second bezel 40
80a, 80b third bezel
82a, 82b opening of the third bezel
101, 102, 103, 104 side end portion of the first bezel
108, 109 end face of the first bezel
201, 202, 203, 204 end portion of the second bezel in the lengthwise direction

1. A display device, comprising:
a display panel; a first bezel; and second bezels,
wherein the display panel is formed in a rectangular plate shape having a display surface, a rear surface opposite to the display surface, and four end faces connected to the display surface and the rear surface,
wherein the first bezel covers at least a part of the rear surface of the display panel, opposite end faces of the display panel, and peripheral portions of the display surface along the opposite end faces,
wherein the second bezels are respectively formed in a box shape having an opening that opens in one direction only, and
wherein the openings of the second bezels respectively enclose end faces not covered with the first bezel in the display panel, peripheral portions of the display surface along said end faces not covered with the first bezel, and side end portions of the first bezel covering the opposite end faces of the display panel.

2. The display device according to claim 1, wherein a part of the first bezel is folded in advance at a substantially right angle at a position that faces a boundary between the end face and the display surface to be covered by the first bezel.

3. The display device according to claim 1, wherein an engaging structure for fixing the first bezel and the second bezel to each other is provided at a portion where the first bezel and the second bezel make contact with each other.

4. The display device according to claim 1, further comprising third bezels, the third bezels being respectively formed in a box shape having an opening that opens in one direction only,
wherein the openings of the third bezels respectively enclose end faces of the first bezel that covers the opposite end faces, end portions of the first bezel that covers respective peripheral portions of the display surface along said opposite end faces, and end portions of the second bezels in a lengthwise direction.
